(19) United States
(12) Patent Application Publication
(10) Pub. No.: US 2024/0048207 A1
(43) Pub. Date: Feb. 8, 2024

(54) METHOD AND APPARATUS FOR TRANSMITTING AND RECEIVING FEEDBACK INFORMATION BASED ON ARTIFICIAL NEURAL NETWORK

(71) Applicant: ELECTRONICS AND TELECOMMUNICATIONS RESEARCH INSTITUTE, Daejeon (KR)

(72) Inventors: Han Jun PARK, Daejeon (KR); Yong Jin KWON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(21) Appl. No.: 18/229,292

(22) Filed: Aug. 2, 2023

(30) Foreign Application Priority Data
Aug. 3, 2022 (KR) 10-2022-0096919
Jun. 19, 2023 (KR) 10-2023-0078343

(51) Int. Cl. H04B 7/06; H04L 5/00

(52) U.S. Cl. CPC H04B 7/0636; H04L 5/0055

(57) ABSTRACT

An operation method of a first communication node may include: inputting first input data including first feedback information to a first encoder of a first artificial neural network corresponding to the first communication node; generating first latent data based on an encoding operation in the first encoder; generating a first feedback signal including the first latent data; and transmitting the first feedback signal to a second communication node, wherein the first latent data included in the first feedback signal is decoded into first restored data corresponding to the first input data in a second decoder of a second artificial neural network corresponding to the second communication node, and the first input data includes first common input data included in a common input data set previously shared between the first communication node and the second communication node.

### CROSS-REFERENCE TO RELATED APPLICATIONS

This application claims priority to Korean Patent Applications No. 10-2022-0096919, filed on Aug. 3, 2022, and No. 10-2023-0078343, filed on Jun. 19, 2023, with the Korean Intellectual Property Office (KIPO), the entire contents of which are hereby incorporated by reference.

### BACKGROUND

### 1. Technical Field

Exemplary embodiments of the present disclosure relate to an artificial neural network-based technique for transmitting and receiving feedback information, and more specifically, to a technique for a transmitting node and a receiving node to transmit and receive feedback information based on artificial neural networks.

### 2. Description of Related Art

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

For the processing of rapidly increasing wireless data after commercialization of the 4G communication system (e.g., communication system supporting LTE), the 5G communication system (e.g., communication system supporting NR) using a frequency band (e.g., frequency band above 6 GHz) higher than a frequency band (e.g., frequency band below 6 GHz) of the 4G communication system as well as the frequency band of the 4G communication system is being considered. The 5G communication system can support enhanced Mobile BroadBand (eMBB), Ultra-Reliable and Low-Latency Communication (URLLC), and massive machine type communication (mMTC) scenarios.

Meanwhile, active research is being conducted on the application of artificial intelligence (AI) and machine learning (ML) techniques in mobile communication. One area of study involves improving the performance of feedback procedures, such as channel state information (CSI) feedback, using AI/ML. However, the artificial neural network structures (or algorithms, etc.) employed in AI/ML techniques may be proprietary assets of terminal providers or service providers, and thus not widely disclosed. In situations where accurate information about these artificial neural network structures is not shared between communication nodes, techniques to enhance the performance of artificial neural network-based feedback transmission/reception operations may be required.

Matters described as the prior arts are prepared to promote understanding of the background of the present disclosure, and may include matters that are not already known to those of ordinary skill in the technology domain to which exemplary embodiments of the present disclosure belong.

### SUMMARY

Exemplary embodiments of the present disclosure are directed to providing a method and an apparatus for transmitting and receiving feedback information based on artificial neural networks, which can enhance the performance of a feedback procedure in a communication system.

According to a first exemplary embodiment of the present disclosure, an operation method of a first communication node may comprise: inputting first input data including first feedback information to a first encoder of a first artificial neural network corresponding to the first communication node; generating first latent data based on an encoding operation in the first encoder; generating a first feedback signal including the first latent data; and transmitting the first feedback signal to a second communication node, wherein the first latent data included in the first feedback signal is decoded into first restored data corresponding to the first input data in a second decoder of a second artificial neural network corresponding to the second communication node, and the first input data includes first common input data included in a common input data set previously shared between the first communication node and the second communication node.

The operation method may further comprise, before the inputting of the first input data, receiving information at least on the second encoder of the second artificial neural network from the second communication node; and configuring the first encoder based on information on the second encoder.

The operation method may further comprise, before the inputting of the first input data, performing a pre-training procedure for pre-training the first artificial neural network, wherein the pre-training procedure may be performed based on a first common latent data set generated in the first communication node based on the common input data set, and a second common latent data set generated in the second communication node based on the common input data set.

The performing of the pre-training procedure may comprise: generating, by the first encoder, the first common latent data set based on the common input data set; receiving, from the second communication node, information on the second common latent data set generated based on the common input data set in the second encoder of the second artificial neural network of the second communication node; and updating the first artificial neural network based on a relationship between the first and second common latent data sets.

The updating of the first artificial neural network may comprise updating the first artificial neural network so that values of one or more loss functions of a first loss function, a second loss function, and a third loss function decrease, the first loss function may be defined based on an error between an input value and an output value of the first artificial neural network, the second loss function may be defined based on a ratio between an input value distance and an output value distance of the first encoder and/or a first decoder of the first artificial neural network, and the third loss function may be defined based on an error between the first and second common latent data sets.

The performing of the pre-training procedure may comprise, before the generating of the first common latent data set, updating the first artificial neural network so that values of one or more of a first loss function and a second loss function decrease, and wherein the first loss function may be defined based on an error between an input value and an output value of the first artificial neural network, and the second loss function may be defined based on a ratio between an input value distance and an output value distance of the first encoder and/or a first decoder of the first artificial network.

The operation method may further comprise, after the transmitting of the first feedback signal, receiving, from the second communication node, information on a third common latent data set generated based on the common input data set in a second encoder of the second artificial neural network of the second communication node; and performing an update procedure for the first artificial neural network based on at least the information on the third common latent data set.

The information on the third common latent data set may include first identification information on the common input data set in a state corresponding to the third common latent data set, and the performing of the update procedure may comprise: determining whether an update for the first artificial neural network has already been performed based on the common input data set in a state corresponding to the first identification information; and in response to determining that the update for the first artificial neural network has already been performed based on the common input data set in the state corresponding to the first identification information, determining that an update for the first artificial neural network based on the third common latent data set is not required.

The first identification information may include at least part of information on a supplier of the common input data set, information on a version of the common input data set, or information on a model of the second artificial neural network of the second communication node.

The operation method may further comprise: determining whether a feedback procedure based on a fallback mode is required; in response to determining that the feedback procedure based on the fallback mode is required, identifying latent variables included in a second common latent data set based on the common input data set at the second communication node; generating second latent data from second input data based on the latent variables; generating a second feedback signal including the second latent data; and transmitting the second feedback signal to the second communication node.

The determining of whether the feedback procedure based on the fallback mode is required may comprise: determining that the feedback procedure based on the fallback mode is required at least one of: when the first artificial neural network is deactivated, when the second artificial neural network is deactivated, when configurations related to artificial neural network-based feedback are changed in the first communication node, or when the first communication node is in handover.

The first artificial neural network may include a first converter at a rear end of the first encoder, and the generating of the latent data may comprise: generating first intermediate data based on the encoding operation on the first input data in the first encoder; and inputting the first intermediate data to the first converter to convert the first intermediate data into the first latent data.

The operation method may further comprise, before the inputting of the first input data, generating a first converter to be used in the second communication node; and transmitting information on the first converter to the second communication node, wherein the first latent data may be converted by the first converter provided from the first communication node before being input to the second decoder at the second communication node.

The operation method may further comprise, when the first artificial neural network further includes a first decoder and a second converter, generating third latent data by inputting third input data to the first encoder; generating second intermediate data by inputting the third latent data to the second converter; and generating third output data corresponding to the third input data by inputting the second intermediate data to the first decoder.

The operation method may further comprise, before the inputting of the first input data, receiving, from the second communication node, information on a second common latent data set generated based on the common input data set in a second encoder of the second artificial neural network of the second communication node; and transmitting pre-training request information for pre-training the first artificial neural network to a first entity, wherein the pre-training request information includes information on the second common latent data set, and the pre-training is performed by the first entity based on the information on the second common latent data set.

The operation method may further comprise, after the transmitting of the first feedback signal, receiving, from the second communication node, information on a third common latent data set generated based on the common input data set in a second encoder of the second artificial neural network of the second communication node; and transmitting update request information for updating the first artificial neural network to a first entity, wherein the update request information includes information on the third common latent data set, and the updating of the first artificial neural network is performed by the first entity based on the information on the third common latent data set.

The update request information may further include information on at least one common data pair composed of at least one common input data included in the common input data set and at least one common latent data included in the third common latent data set.

According to a second exemplary embodiment of the present disclosure, an operation method of a first communication node may comprise: receiving a first feedback signal from a second communication node; obtaining first latent data included in the first feedback signal; performing a decoding operation on the first latent data based on a first decoder of a first artificial neural network corresponding to the first communication node; and obtaining first feedback information based on first restored data output from the first decoder, wherein the first feedback information corresponds to second feedback information generated for a feedback procedure in the second communication node, the second communication node generates the first latent data included in the first feedback signal by encoding first input data including the second feedback information through a second encoder of a second artificial neural network corresponding to the second communication node, and the first input data includes first common input data included in a common input data set previously shared between the first communication node and the second communication node.

The operation method may further comprise, before the receiving of the first feedback signal, generating a first common latent data set for a pre-training procedure for the second artificial neural network of the second communication node by encoding the common input data set through a first encoder of the first artificial neural network; and transmitting the first common latent data set to the second communication node, wherein the pre-training procedure is performed based on the first common latent data set and a second common latent data set generated in the second communication node based on the common input data set.

The operation method may further comprise, after the obtaining of the first feedback information, generating a third common latent data set for an update procedure for the second artificial neural network of the second communication node by encoding the common input data set through a first encoder of the first artificial neural network; and transmitting information on the third common latent data set to the second communication node, wherein the information on the third common latent data set includes first identification information on the common input data set in a state corresponding to the third common latent data set, and the first identification information is used to determine whether an update for the second artificial neural network is required in the second communication node.

According to exemplary embodiments of a communication system, an artificial neural network-based method and apparatus are employed for transmitting and receiving feedback information. Communication nodes in the system, such as base stations and terminals, may utilize artificial neural networks for feedback procedures, including CSI feedback. In the transmitting node, feedback information is generated in a compressed form using an artificial neural network encoder. The receiving node, on the other hand, receives the compressed feedback information from the transmitting node and employs an artificial neural network decoder to restore the original feedback information. This approach enhances the performance of the artificial neural network-based feedback information transmission and reception operations.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram for describing an exemplary embodiment of an artificial neural network-based feedback technique in a communication system.

FIGS. 4A to 4C are conceptual diagrams for describing a first exemplary embodiment of an artificial neural network-based feedback method.

FIG. 5 is a conceptual diagram for describing a second exemplary embodiment of an artificial neural network-based feedback method.

FIG. 6 is a conceptual diagram for describing third and fourth exemplary embodiments of an artificial neural network-based feedback method.

FIG. 7 is a conceptual diagram for describing fifth and sixth exemplary embodiments of an artificial neural network-based feedback method.

FIGS. 8A and 8B are conceptual diagrams for describing a seventh exemplary embodiment of an artificial neural network-based feedback method.

FIGS. 9A to 9D are conceptual diagrams for describing an eighth exemplary embodiment of an artificial neural network-based feedback method.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like. Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

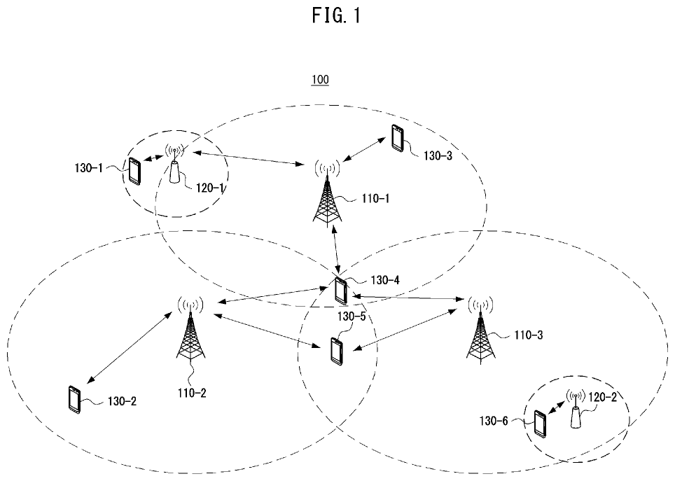

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

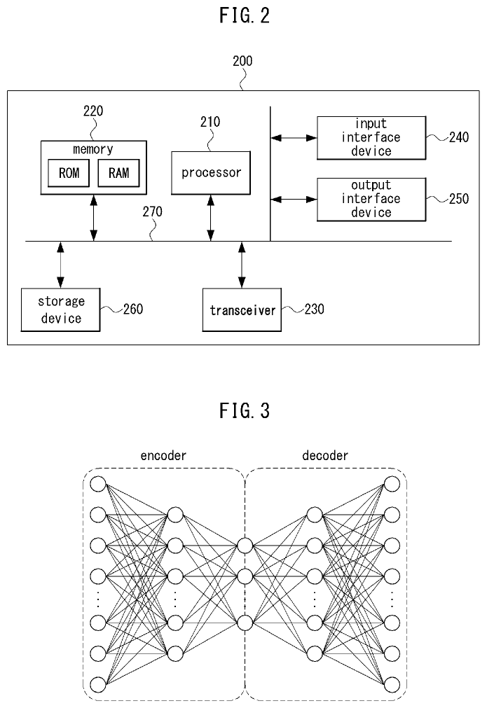

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, artificial neural network-based channel state information transmission and reception methods in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a receiving node is described, a corresponding transmitting node may perform an operation corresponding to the operation of the receiving node. Conversely, when an operation of a transmitting node is described, a corresponding receiving node may perform an operation corresponding to the operation of the transmitting node.

FIG. 3 is a conceptual diagram for describing an exemplary embodiment of an artificial neural network-based feedback technique in a communication system.

Recently, research on the application of artificial intelligence (AI) and machine learning (ML) technologies to mobile communication is actively underway. For example, methods for improving the performance of a feedback procedure such as channel state information (CSI) feedback based on AI/ML are being studied. However, artificial neural network structures (or algorithms, etc.) according to AI/ML technologies are judged as unique assets of terminal providers or service providers, and may not be widely disclosed. As such, a technique for improving the performance of artificial neural network-based feedback transmission/reception operations even in a situation where information on the structure of the artificial neural network itself is not accurately shared between communication nodes may be required.

Specifically, in order for a base station to apply a transmission technique such as multiple input multiple output (MIMO) or precoding in a communication system, the base station may need to acquire radio channel information between the base station and a terminal. In order for the base station to acquire radio channel information, the following schemes may be used.
When the base station transmits a reference signal, the terminal may receive the reference signal transmitted from the base station. The terminal may measure CSI using the reference signal received from the base station. The terminal may report the measured CSI to the base station. This scheme may be referred to as ‘CSI feedback’ or ‘CSI reporting’.
When the terminal transmits a reference signal, the base station may receive the reference signal transmitted from the terminal. The base station may directly measure an uplink channel using the reference signal received from the terminal, and may assume or estimate a downlink channel based on the measured uplink channel. This scheme may be referred to as ‘channel sounding’.

An exemplary embodiment of the communication system may support one or both of the two channel information acquisition schemes. For example, in relation to the CSI feedback scheme, feedback information such as a channel quality indicator (CQI), precoding matrix indicator (PMI), and rank indicator (RI) may be supported. Meanwhile, in relation to the channel sounding scheme, a sounding reference signal (SRS), which is a reference signal for estimating an uplink channel, may be supported.

Specifically, the CQI may be information corresponding to a downlink signal to interference and noise power ratio (SINR). The CQI may be expressed as information on a modulation and coding scheme (MCS) that meets a specific target block error rate (BLER). The PMI may be information on a precoding selected by the terminal. The PMI may be expressed based on a pre-agreed codebook between the base station and the terminal. The RI may mean the maximum number of layers of a MIMO channel.

Which scheme among the CSI feedback scheme and the channel sounding scheme is more effective for acquiring channel information at the base station and performing communication with the terminal according to the channel information may be determined differently according to a communication condition or communication system. For example, in a system in which reciprocity between a downlink channel and an uplink channel is guaranteed or expected (e.g., time division duplex (TDD) system), it may be determined that the channel sounding scheme in which the base station directly acquires channel information is relatively advantageous. However, the uplink reference signals used for the channel sounding scheme may have a high transmission load, and thus may not be easily applied to all terminals within the network.

Even in the CSI feedback scheme, a technique enabling sophisticated channel representation may be required. In an exemplary embodiment of the communication system, two types of codebooks may be supported to convey the PMI information. For example, a Type 1 codebook and a Type 2 codebook may be supported to convey the PMI information. Here, the Type 1 codebook may represent a beam group with oversampled discrete Fourier transform (DFT) matrixes, and one beam selected from among them (or information on the selected one beam) may be reported. On the other hand, according to the Type 2 codebook, a plurality of beams may be selected, and information composed of a linear combination of the selected beams may be reported. The Type 2 codebook may be easier to support a transmission technique such as multi-user MIMO (MU-MIMO) compared to the Type 1 codebook. However, in the case of the Type 2 codebook, a codebook structure thereof is relatively complex, and thus the load of the CSI feedback procedure may greatly increase.

A technique for reducing the load of transmission and reception operations of feedback information such as CSI may be required. For example, a method of combining technologies such as AI and ML to a transmission and reception procedure (i.e., feedback procedure) of feedback information such as CSI may be considered.

Recently, AI and ML technologies have made remarkable achievements in the field of image and natural language. Thanks to the development of AI/ML technologies, research in academia and industry is actively being conducted to apply AI/ML technologies to mobile communication systems. For example, the 3rd generation partnership project (3GPP), an international standardization organization, is conducting researches to apply AI/ML technologies to air interfaces of mobile communication systems. In such the researches, the 3GPP are considering the following three use cases as representative use cases.
(1) AWL-based CSI feedback
(2) AI/ML based beam management
(3) AI/ML based positioning

In these AI/ML-based CSI feedback use cases, the 3GPP is discussing a CSI compression scheme for compressing channel information based on AI/ML and a CSI prediction scheme for predicting channel information at a future time point based on AI/ML. In addition, in the AWL-based beam management use case, the 3GPP is discussing a beam prediction scheme for predicting beam information in the time/space domain based on AI/ML. In addition, in the AWL-based positioning use case, the 3GPP is discussing a method of directly estimating a position of a terminal based on AI/ML and a method of assisting conventional positioning techniques based on AI/ML.

Meanwhile, the academic world may be conducting researches in the direction of applying AI/ML techniques to all areas of mobile communications, including the above-described representative use cases. Specifically, in relation to the AI/ML-based CSI feedback use case, academia may be proposing a CSI compression scheme that compresses channel information by utilizing a convolutional neural network (CNN)-based autoencoder, one of AI/ML technologies. This auto-encoder technique may refer to a neural network structure that copies inputs to outputs. In such the auto-encoder, the number of neurons of a hidden layer between an encoder and a decoder may be set to be smaller than that of an input layer to compress (or reduce dimensionality) data. In this AWL-based CSI compression technique, an artificial neural network may be trained to correspond channel state information to latent variables (or codes) on a latent space by compressing channel information into the channel state information. However, in such the AWL-based CSI compression technique, the channel state information compressed into the latent space cannot be described and controlled.

In an exemplary embodiment of the communication system, the following AI/ML models may be considered.
1. One-sided AI/ML Model
1-A. AI/ML model in which inference is performed entirely in the terminal or network (e.g., UE-sided AI/ML model, Network-sided AI/ML model, etc.)
2. Two-sided AI/ML Model
2-A. Paired AI/ML model(s) in which joint inference is performed
2-B. Here, ‘joint inference’ includes an AI/ML inference in which inference is jointly performed across the terminal and the network.
2-C. For example, a first part of the inference may be performed by the terminal and the remaining part may be performed by the base station.
2-C. On the other hand, the first part of the inference may be performed by the base station and the remaining part may be performed by the terminal.

According to the above-described classification of AI/ML model types, the auto-encoder-based CSI feedback scheme may correspond to the two-sided AI/ML model. Specifically, the terminal may generate a CSI feedback by utilizing an artificial neural network-based encoder of the terminal. The base station may interpret the CSI feedback generated by the terminal by using an artificial neural network-based decoder of the base station. Since the two-sided AI/ML model defines one AI/ML algorithm by using a pair of AI/ML models, it may be preferable to train the pair of AWL models together.

However, the artificial neural network structure (or algorithm, etc.) according to the AI/ML technologies are judged as a unique asset of the terminal provider or service provider, and may not be widely disclosed. Accordingly, without a process of directly exchanging AI/ML model information between different network nodes or performing joint training on the pair of AI/ML models within the two-sided AI/ML model, artificial neural networks for CSI feedback may be individually configured. Even when different network nodes individually configure artificial neural networks for CSI feedback in the above-described manner, a technique for ensuring compatibility may be required for correct interpretation of feedback information. For example, a scheme in which the terminal and the base station individually configure artificial neural network-based encoder and decoder, but perform training of the encoder and/or decoder so that the decoder can accurately interpret an encoding result of the encoder may be applied.

Hereinafter, for convenience of description, an artificial neural network learning and configuration method proposed in the present disclosure will be mainly described in terms of a downlink of a wireless mobile communication system composed of a base station and a terminal. However, proposed methods of the present disclosure may be extended and applied to any wireless mobile communication system composed of a transmitter and a receiver. Hereinafter, channel state information may be an arbitrary compressed form of channel information.

Referring to FIG. 3, in an exemplary embodiment of an artificial neural network based feedback technique, a base station and/or a terminal may each include a channel state information feedback apparatus. The channel state information feedback apparatus may include an encoder and/or a decoder. In this case, the encoder and decoder may form an auto-encoder. The encoder may be located at least at the terminal, and the decoder may be located at least at the base station. Such the auto-encoder may perform data compression (or dimensionality reduction) by setting the number of neurons at a hidden layer between the encoder and the decoder to be smaller than that of an input layer. Such the autoencoder may be configured based on a convolutional neural network (CNN). Here, the encoder may be referred to as a channel compression artificial neural network.

The configurations described with reference to FIG. 3 are merely examples for convenience of description, and exemplary embodiments of the artificial neural network-based feedback technique are not limited thereto. The configurations described with reference to FIG. 3 may be equally or similarly applied even in a situation where the base station is replaced by the terminal and the terminal is replaced by the base station. For example, at least part of the configurations described with reference to FIG. 3 may be applied identically or similarly to a situation in which the base station transmits feedback information to the terminal. Alternatively, the configurations described with reference to FIG. 3 may be applied identically or similarly to a situation in which the base station and the terminal are replaced by a first communication node and a second communication node, respectively. For example, at least part of the configurations described with reference to FIG. 3 may be applied identically or similarly to a situation in which a first communication node and a second communication node transmit and receive feedback information in uplink communication, downlink communication, si del ink communication, unicast-based communication, multicast-based communication, broadcast-based communication, and/or the like.

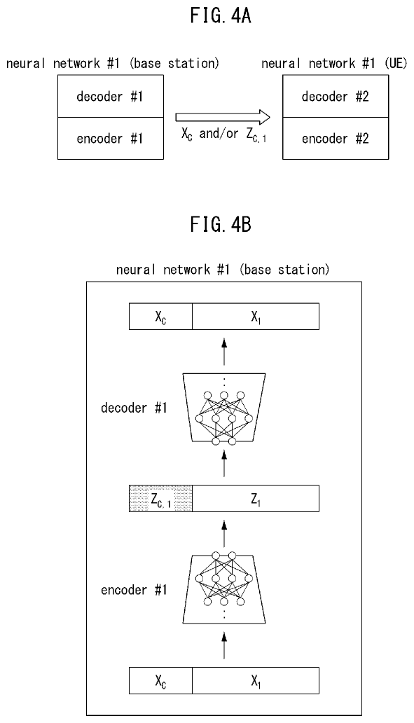

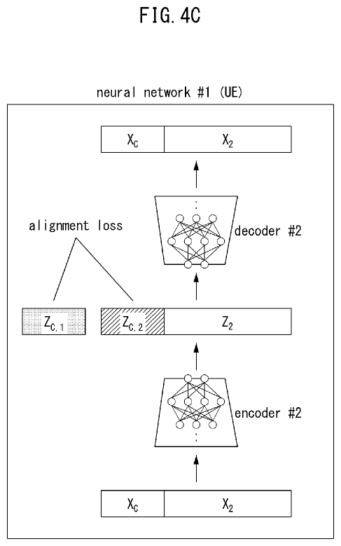

FIGS. 4A to 4C are conceptual diagrams for describing a first exemplary embodiment of an artificial neural network-based feedback method.

Referring to FIGS. 4A to 4C, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for the feedback procedure. Hereinafter, in describing the first exemplary embodiment of the artificial neural network-based feedback method (hereinafter referred to as ‘first exemplary embodiment of feedback method’) with reference to FIGS. 4A to 4C, descriptions overlapping with those described with reference to FIGS. 1 to 3 may be omitted.

### First Exemplary Embodiment of Feedback Method

Referring to FIG. 4A, in the first exemplary embodiment of the feedback method, the base station and the terminal may each include an artificial neural network (hereinafter referred to as ‘neural network’) configured for the feedback procedure (e.g., CSI feedback procedure). The base station may include a neural network #1, and the terminal may include a neural network #2. The neural network #1 and the neural network #2 may each have an auto-encoder structure. Each neural network may include an encoder and a decoder. For example, the neural network #1 included in the base station may include an encoder #1 and a decoder #1. The neural network #2 included in the terminal may include an encoder #2 and a decoder #2.

Input data X may be input to each neural network. The input data X input to each neural network may be encoded into latent data Z by the encoder. The latent data in each neural network may correspond to compressed (or dimensionally-reduced) data from the input data X, identically or similarly to that described with reference to FIG. 3. The latent data Z in each neural network may be decoded into output data by the decoder. The output data generated by each neural network in the above-described manner may be the same as or similar to the input data X. In other words, in each neural network, the decoder may reconstruct the input data from the latent data.

The input data X input to each neural network may include common input data X_{C}. The latent data Z generated through encoding in each neural network may include reference latent data Z_{C} corresponding to the common input data X_{C}. For example, the encoder #1 of the neural network #1 may generate first common latent data Z_{C,1} corresponding to the common input data X_{C}. The base station may transmit information on the common input data X_{C} and/or information on the first common latent data to the terminal. Through this, the performance of the CSI feedback operation may be improved.

Referring to FIG. 4B, the input data input to the neural network #1 of the base station may include the common input data X_{C} and first input data X₁. The common input data X_{C} may be included in a preconfigured common input data set X_{C,set}. In other words, the common input data X_{C} input to the neural network #1 of the base station may be determined as values included in the common input data set X_{C,set}.

The encoder #1 of the base station may encode the input data including the common input data X_{C} and first input data X₁ to generate the latent data. The generated latent data may include first common latent data Z_{C,1} and first latent data Z₁. Here, the first common latent data Z_{C,1} may mean a part corresponding to the common input data X_{C} among the latent data generated by the encoder #1. The first latent data Z₁ may mean a part corresponding to the first input data X₁ among the latent data generated by the encoder #1. The first latent data Z_{C,1} generated through encoding in the above-described manner may be included in the first common latent data set Z_{C,1,set} corresponding to the common input data set X_{C,set}. The decoder #1 of the base station may decode the latent data including the first common latent data Z_{C,1} and the first latent data Z₁ to generate output data. The generated output data may include the common input data X_{C} and the first input data X₁.

Referring to FIG. 4C, the input data input to the neural network #2 of the terminal may include the common input data X_{C} and second input data X₂. The common input data X_{C} may be included in the preconfigured common input data set X_{C,set}. In other words, the common input data X_{C} input to the neural network #2 of the terminal may be determined as values included in the common input data set X_{C,set}.

The encoder #2 of the terminal may generate latent data by encoding the input data including the common input data X_{C} and the second input data X₂. The generated latent data may include second common latent data Z_{C,2} and second latent data Z₂. Here, the second common latent data Z_{C,2} may mean a part corresponding to the common input data X_{C} among the latent data generated by the encoder #2. The second latent data Z₂ may mean a part corresponding to the second input data X₂ among the latent data generated by the encoder #1. The second latent data Z_{C,2} generated through encoding in the above-described manner may be included in the second common latent data set Z_{C,2,set} corresponding to the common input data set X_{C,set}. The decoder #2 of the terminal may decode the latent data including the second common latent data Z_{C,2} and the second latent data Z₂ to generate output data. The generated output data may include the common input data X_{C} and the second input data X₂.

Information on the common input data set X_{C,set} and/or information on the first common latent data set Z_{C,1,set} may be shared between the base station and the terminal. For example, the base station may transmit information on the common input data set X_{C,set} and/or information on the first common latent data set Z_{C,1,set} to the terminal. Alternatively, information on the common input data set X_{C,set} and/or information on the first common latent data set Z_{C,1,set} may be shared between the base station and the terminal through a separate entity connected to the base station and/or the terminal. The shared information on the common input data set X_{C,set} and/or the first common latent data set Z_{C,1,set} may be utilized in the CSI feedback procedure.

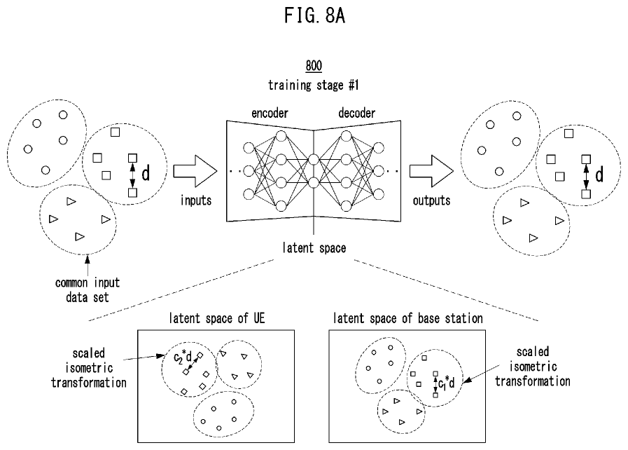

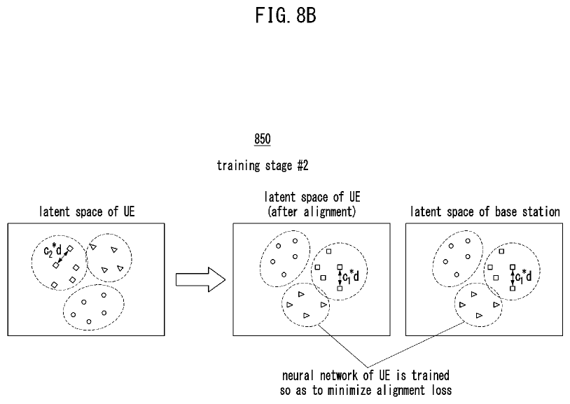

For example, the terminal may compare the first common latent data set Z_{C,1,set} encoded by the encoder #1 included in the neural network #1 of the base station and the common latent data set Z_{C,2,set} encoded by the encoder #2 included in the neural network #2 of the terminal. In other words, the terminal may compare the first common latent data set Z_{C,1,set} and the second common latent data set Z_{C,2,set} respectively encoded by the encoders #1 and #2 from the same common input data set X_{C,set}. The terminal may identify an alignment error which is an error between the first common latent data set Z_{C,1,set} and the second common latent data set Z_{C,2,set}. The alignment loss identified in the above-described manner may be used for training of the neural network #2 of the terminal. For example, the terminal may perform supervised learning (or unsupervised learning) based on a predetermined loss function (hereinafter referred to as ‘total loss function’) for training of the neural network #2. The terminal may perform training in a direction in which a value of the total loss function decreases. The total loss function may be configured based on one or more loss functions. For example, the total loss function may be configured based on one or a combination of two or more loss functions among as a first loss function, a second loss function, and a third loss function. Here, the first loss function, second loss function, and third loss function may be the same as or similar to a first loss function, second loss function, and third loss function to be described with reference to FIGS. 8A and 8B. The terminal may perform training based on the total loss function configured based on one or a combination of two or more loss functions among the first loss function, second loss function, and third loss function. The total loss function may be configured to be fixed or variable.

In an exemplary embodiment of the communication system, the terminal may input second input data to the neural network #2 configured for the CSI feedback procedure. Here, the second input data X₂ may be input data for generating CSI feedback information. The second input data X₂ may correspond to information such as CSI and CSI report. Alternatively, the second input data X₂ may be generated based on the information such as CSI and CSI report.

The terminal may configure first feedback information for CSI feedback using the encoder #2 of the neural network #2. The terminal may transmit the first feedback information to the base station. The first feedback information transmitted in the above-described manner may correspond to the second latent data Z_{C,2}. The base station may receive the first feedback information transmitted from the terminal. The base station may decode the first feedback information transmitted from the terminal using the decoder #1 of the neural network #1 configured for the CSI feedback procedure. Through decoding in the decoder #1, first output data may be generated. The first output data generated in the above-described manner may correspond to a result of restoring the second input data X₂ input to the encoder #2 in the terminal. Through this, the base station may receive the CSI feedback in a compressed (or dimensionally reduced) form from the terminal.

The technologies for the artificial neural networks or their structures mounted on the base station, terminal, etc. may correspond to technologies requiring security as an asset of each company. In order to maintain the security of artificial neural network technology, the entire structure of artificial neural network models for communication between the base station and the terminal may not be disclosed or shared. That is, only a part of the structures or minimal structures of the artificial neural network models for communication between the base station and the terminal may be shared. Alternatively, the structures of artificial neural network models for communication between the base station and the terminal may not be shared.

The base station and the terminal may independently configure their own artificial neural network (e.g., neural network #1 and neural network #2). The neural network #1 and the neural network #2 configured for the CSI feedback procedure between the base station and the terminal may not be configured identically to each other. Due to the discrepancy between the neural network #1 and the neural network #2, when the base station decodes the CSI feedback information, which is generated by the terminal through encoding by the neural network #2, by the neural network #1, there may occur a discrepancy between the input data at the terminal and the output data at the base station. In other words, due to the discrepancy between the neural network #1 and the neural network #2, the base station may misinterpret the CSI feedback information received from the terminal.

In the first exemplary embodiment of the feedback method, the common input data set X_{C,set} may be shared between the base station and the terminal. For example, the base station and the terminal may directly share the common input data set X_{C,set}. Alternatively, the base station may share the common input data set X_{C,set} with a separate entity (hereinafter referred to as a ‘first entity’) connected to the base station and/or the terminal. Here, the first entity may be an upper entity of the base station and/or the terminal. The base station and/or the terminal may transmit and receive information between each other through the first entity. The first entity may manage artificial neural networks of the base station and/or the terminal. For example, the first entity may manage the neural network #2 of the terminal described with reference to FIGS. 4A to 4C. The first entity may perform training and/or update for the neural network #2 (or the encoder #2 and decoder #2 constituting the neural network #2).

The base station may generate the first common latent data set Z_{C,1,set} by encoding the common input data set X_{C,set} through the neural network #1 (or the encoder #1 included in the neural network #1) of the base station. The base station may transmit the first common latent data set Z_{C,1,set} to the terminal (or the first entity).

When the terminal directly manages the neural network #2, the base station may transmit the first common latent data set Z_{C,1,set} to the terminal. Based on the neural network #2 (or the encoder #2 included in the neural network #2), the terminal may generate the second common latent data set Z_{C,2,set} by encoding the common input data set X_{C,set}. The terminal may perform training of the neural network #2 in a direction such that an error between the second common latent data set Z_{C,2,set} and the first common latent data set Z_{C,1,set} is reduced. Accordingly, the CSI feedback information generated by the terminal based on the neural network #2 may be accurately interpreted by the neural network #1 in the base station. This may mean that the neural network #1 of the base station and the neural network #2 of the terminal are compatible with each other.

When the first entity manages the neural network #2 of the terminal, the base station may transmit the first common latent data set Z_{C,1,set} to the first entity. The first entity may generate the second common latent data set Z_{C,2,set} by encoding the common input data set X_{C,set} through the neural network #2 (or the encoder #2 included in the neural network #2). The first entity may perform training of the neural network #2 in a direction such that an error between the second common latent data set Z_{C,2,set} and the first common latent data set Z_{C,1,set} is reduced. The first entity may transmit information on the neural network #2 that has been updated or determined through training to the terminal. The terminal may update the neural network #2 based on the information received from the first entity. Accordingly, the CSI feedback information generated by the terminal based on the neural network #2 may be accurately interpreted by the neural network #1 in the base station. This may mean that the neural network #1 of the base station and the neural network #2 of the terminal are compatible with each other. When the first entity manages the neural network #2 of the terminal as described above, the training operation of the neural network #2 of the terminal may mean the training operation of the neural network #2 by the first entity (or through the first entity).

The common input data set X_{C,set} may be a part (or subset) of the entire input data set to be learned by the base station and/or the terminal. Accordingly, the terminal may follow the encoding scheme of the base station in encoding at least a part (i.e., common input data set X_{C,set}) of the entire input data. Among the input data to be learned by the base station, the remaining input data excluding the common input data set X_{C,set} may be expressed as the first input data X₁. That is, the first input data X₁ may be input data for training only the base station among the base station and the terminal. Among the input data to be learned by the terminal, the remaining input data excluding the common input data set X_{C,set} may be expressed as the second input data X₂. That is, the second input data X₂ may be input data for training only the terminal among the base station and the terminal.

When statistical characteristics of the entire data sets learned by the base station and the terminal are similar, manifolds in the latent spaces formed by the base station's neural network #1 and the terminal's neural network #2, respectively, may have similar shapes but may not be aligned. As the neural network #2 of the terminal is updated based on the information of the first common latent data set Z_{C,1,set} provided from the base station, at least a part corresponding to each other on the manifolds of the neural network #1 and the neural network #2 may be aligned with each other. Accordingly, the effect of eventually inducing the entire manifolds to be aligned may be expected.

The configurations according to the first exemplary embodiment of the feedback method described above may be applied together with at least part of other exemplary embodiments within a range that does not conflict with the other exemplary embodiments disclosed in the present disclosure.

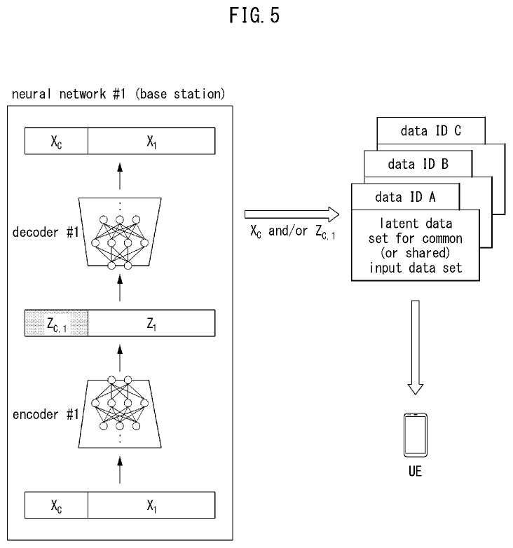

FIG. 5 is a conceptual diagram for describing a second exemplary embodiment of an artificial neural network-based feedback method.

Referring to FIG. 5, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for a feedback procedure. Hereinafter, in describing the second exemplary embodiment of the artificial neural network-based feedback method (hereinafter, ‘second exemplary embodiment of feedback method’) with reference to FIG. 5, descriptions overlapping with those described with reference to FIGS. 1 to 4C may be omitted.

### Second Exemplary Embodiment of Feedback Method

In the second exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

The first common latent data set Z_{C,1,set} may be generated by the base station encoding the common input data set X_{C,set} through the neural network #1. The base station may transmit identification information on information included in the common input data set X_{C,set} and/or the first common latent data set Z_{C,1,set} to the terminal (or the first entity managing the neural network #2 of the terminal).

The identification information for the common input data set X_{C,set} and/or the first common latent data set Z_{C,1,set} may include, for example, the following information.
1. Information on a data provider
2. Information on a version
3. Information on a mode of the neural network #1 of the base station
3-A. Type of the neural network
3-B. Complexity
3-C. Degree of learning

In the second exemplary embodiment of the feedback method, compatibility between the neural network #1 of the base station and the neural network #2 of the terminal may be required. In order to maintain compatibility between the neural network #1 and the neural network #2, when the neural network #1 is updated in the base station, the neural network #2 may also need to be updated in the terminal. For example, when an update of the common input data set X_{C,set} or the first common latent data set Z_{C,1,set} occurs in the base station, the neural network #1 may be updated. Accordingly, the neural network #2 may need to be updated together. The base station may transmit information on the first common latent data set Z_{C,1,set} to the terminal (or the first entity). The terminal (or the first entity) may update the neural network #2 based on the first common latent data set Z_{C,1,set}. In other words, the terminal (or the first entity) may perform additional training on the neural network #2 based on the first common latent data set Z_{C,1,set}. When the common input data set X_{C,set} or the first common latent data set Z_{C,1,set} is not updated, the neural network #2 may not need to be updated. In other words, when the neural network #2 of the terminal has already been updated based on a specific first common latent data set Z_{C,1,set} (or common input data set X_{C,set}), additional updates based on the same first common latent data set Z_{C,1, set} (or common input data set X_{C,set}) may not be needed. If additional updates based on the same first common latent data set Z_{C,1,set} (or the same common input data set X_{C,set}) is performed, computation resources may be unnecessarily wasted.

The base station may transmit the identification information on the first common latent data set Z_{C,1,set} (or common input data set X_{C,set}) to the terminal (or the first entity). Accordingly, the terminal (or the first entity) may determine whether it has previously received the first common latent data set Z_{C,1,set} (or common input data set X_{C,set}) received from the base station. In other words, the terminal (or the first entity) may determine whether to update the neural network #2 based on the first common latent data set Z_{C,1,set} (or common input data set X_{C,set}) received from the base station.

When updates on the neural network #2 based on a data set having the same identification information as that of the first common latent data set Z_{C,1,set} (or common input data set X_{C,set}) received from the base station at a specific time point has already been performed, the terminal (or the first entity) may determine that updates on the neural network #2 is not required. On the other hand, when updates on the neural network #2 has not been performed based on a data set having the same identification information as that of the first common latent data set Z_{C,1,set} (or common input data set X_{C,set}) received from the base station at a specific time point, the terminal (or the first entity) may determine that the neural network #2 needs to be updated.

The configurations according to the second exemplary embodiment of the feedback method described above may be applied together with at least part of other exemplary embodiments within a range that does not conflict with the other exemplary embodiments disclosed in the present disclosure.

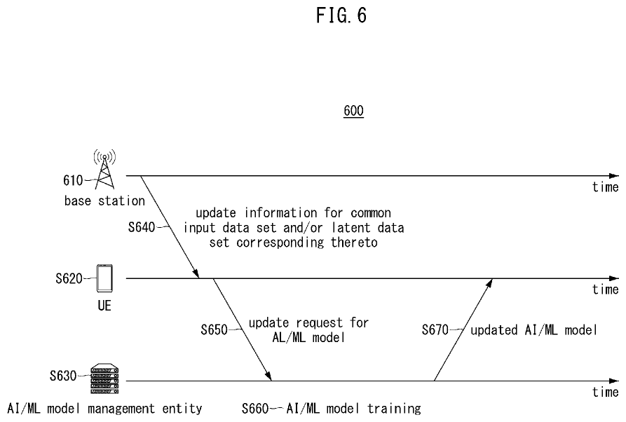

FIG. 6 is a conceptual diagram for describing third and fourth exemplary embodiments of an artificial neural network-based feedback method.

Referring to FIG. 6, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for a feedback procedure. Hereinafter, in describing the third exemplary embodiment of the artificial neural network-based feedback method (hereinafter, ‘third exemplary embodiment of feedback method’) and the fourth exemplary embodiment of the artificial neural network-based feedback method (hereinafter, ‘fourth exemplary embodiment of feedback method’) with reference to FIG. 6, descriptions overlapping with those described with reference to FIGS. 1 to 5 may be omitted.

### Third Exemplary Embodiment of Feedback Method

In the third exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

In the third exemplary embodiment of the feedback method, a communication system 600 may include a base station 610, a terminal 620, and a first entity 630. The first entity 630 may be the same as or similar to the first entity described with reference to FIGS. 4A to 5. The first entity 630 may manage artificial neural networks or models thereof of the base station 610 and/or terminal 620. The first entity 630 may be referred to as an ‘AWL model management entity’.

The feedback procedure may be performed based on the neural network #1 of the base station 610 and the neural network #2 of the terminal 620. The first entity 630 may manage the neural network #2 or a model thereof of the terminal 620. For example, the first entity 630 may perform operations such as generating, training, and updating of the model of the neural network #2 used by the terminal 620. Information on the model of the neural network #2 generated or updated through training may be transmitted to the terminal 620. The terminal 620 may perform the feedback procedure using the updated neural room #2 based on the information provided from the first entity 630. Through this, the individual terminal 620 may not consume a large amount of computation for training the artificial neural network.

The first entity 630 managing the neural network #2 of the terminal 620 may be associated with a provider of the terminal 620 rather than associated with a service provider of the base station 610. That is, it may not be easy for the base station 610 to be directly connected to the first entity 630. In this case, update information or an update request of the base station 610 may be transmitted to the first entity 630 through the terminal 620.

In the third exemplary embodiment of the feedback method, the base station 610 may transmit first update information to the terminal 620 (S640). The terminal 620 may receive the first update information transmitted from the base station 610 (S640). The first update information transmitted and received in the step S640 may correspond to update information of the common input data set and/or the latent data set corresponding thereto. That is, the first update information may be update information of the common input data set X_{C,set} and/or the first common latent data set Z_{C,1,set}. The first update information may include information of the updated common input data set X_{C,set} and/or information of the updated first common latent data set Z_{C,1,set}. Meanwhile, the first update information may include information corresponding to an updated part in the common input data set X_{C,set} and/or information corresponding to an updated part in the first common latent data set Z_{C,1,set}. The first update information may include the identification information described with reference to FIG. 5.

The terminal 620 may transmit a first update request to the first entity 630 (S650). The first entity 630 may receive the first update request transmitted from the terminal 620 (S650). The first update request transmitted and received in the step S650 may include at least a part of the first update information received by the terminal 620 in the step S640. For example, the first update request transmitted and received in the step S650 may include all of the first update information received by the terminal 620 in the step S640. Alternatively, the terminal 620 may determine whether the model of the neural network #2 needs to be updated based on the first update information received in the step S640. When it is determined that the model of the neural network #2 needs to be updated, the terminal 620 may transmit the first update request including at least a part of the first update information received in the step S640 to the first entity 630.

The first entity 630 may update the model of the neural network #2 based on the first update request received in the step S650 (S660). For example, the first entity 630 may perform training on the model of the neural network #2 configured as an AI/ML model. The first entity 630 may perform training on the model of the neural network #2 based on the update information of the common input data set X_{C,set} and/or the first common latent data set Z_{C,1,set} included in the first update request. Here, the first entity 630 may determine whether the model of the neural network #2 needs to be updated based on the first update request received in the step S650. When it is determined that the model of the neural network #2 needs to be updated, the first entity 630 may perform training on the model of the neural network #2 based on the first update request received in the step S650.

The first entity 630 may transmit second update information to the terminal 620 (S670). The terminal 620 may receive the second update information transmitted from the first entity 630 (S670). The first entity 630 may include information on the updated neural network #2 model in the second update information. Alternatively, the second update information may include information required for the terminal 620 to update the model of the neural network #2. When the neural network #1 of the base station 610 is updated based on the operations in the steps S640 to S670, the neural network #2 of the terminal 620 may be updated.

The configurations according to the third exemplary embodiment of the feedback method described above may be applied together with at least part of other exemplary embodiments within a range that does not conflict with the other exemplary embodiments disclosed in the present disclosure.

### Fourth Exemplary Embodiment of Feedback Method

In the fourth exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

Referring to FIG. 6, the base station 610 may transmit first update information to the terminal 620 (S640). Here, the first update information may be delivered in the following form.
1. Information on the (updated) first common latent data set Z_{C,1,set}
1-A. An order of the common input data X corresponding to each of the first common latent data Z_{C,1} constituting the first common latent data set Z_{C,1,set} may be determined based on an order of the first common latent data Z_{C,1}.
2. Information on a first common data pair set P_{C,1,set}, which is a set of (updated) first common data pairs P_{C,1}
2-A. The first common data pair P_{C,1} may be defined as a pair of (updated) common input data X_{C} and (updated) first common latent data Z_{C,1}.
3. Information on a first function fc for obtaining the (updated) first common latent data Z_{C,1}
3-A. The first function fc may be configured to output the first common latent data Z_{C,1} according to input of the common input data X_{C}.
3-B, The first function fc may be information of the neural network #1 outputting the first common latent data Z_{C,1} (or information of the encoder #1 included in the neural network #1) according to input of the common input data X_{C}.

The configurations according to the fourth exemplary embodiment of the feedback method described above may be applied together with at least part of other exemplary embodiments within a range that does not conflict with the other exemplary embodiments disclosed in the present disclosure.

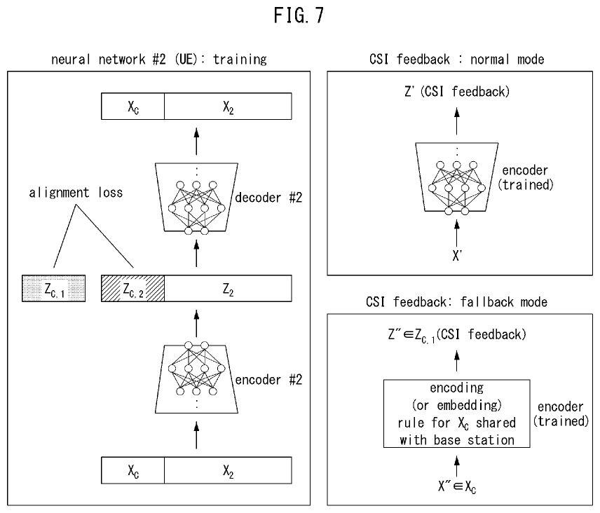

FIG. 7 is a conceptual diagram for describing fifth and sixth exemplary embodiments of an artificial neural network-based feedback method.

Referring to FIG. 7, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for a feedback procedure. Hereinafter, in describing the fifth exemplary embodiment of the artificial neural network-based feedback method (hereinafter, fifth exemplary embodiment of feedback method) and the sixth exemplary embodiment of the artificial neural network-based feedback method (hereinafter, sixth exemplary embodiment of feedback method) with reference to FIG. 7, descriptions overlapping with those described with reference to FIGS. 1 to 6 may be omitted.

### Fifth Exemplary Embodiment of Feedback Method

In the fifth exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

In the fifth exemplary embodiment of the feedback method, the base station and the terminal may perform a feedback procedure in a normal mode based on the neural network #1 and the neural network #2. Here, the normal mode may include a feedback procedure based on at least one of the first to fourth exemplary embodiments of the feedback method described with reference to FIGS. 4A to 6.

When such the feedback procedure is not normally performed, the feedback procedure of the base station and/or terminal may be performed in a fallback mode. Situations in which the feedback procedure is performed in the fallback mode may include, for example, the following situations.
1. A case when the neural network #1 is deactivated
1-A. When the base station does not support the neural network #1, the neural network #1 may be deactivated.
1-B. Before the base station configures the neural network #1, the neural network #1 may be deactivated.
1-C. While the base station is updating the neural network #1, the neural network #1 may be deactivated.
2. A case when the neural network #2 is deactivated
2-A. When the base station does not support the neural network #2, the neural network #2 may be deactivated.
2-B. Before the base station configures the neural network #2, the neural network #2 may be deactivated.
2-C. While the base station is updating the neural network #2, the neural network #2 may be deactivated.
3. If there is a change in the configurations related to artificial neural network-based feedback (e.g., configurations related to CSI feedback)
4. In case of a handover process

In the fallback mode, the terminal may perform the feedback procedure in one of the following manners.
1. Perform feedback using only latent variables (or codes) in the first common latent data set Z_{C,1,set}
2. Perform feedback as a linear combination of latent variables (or codes) in the first common latent data set Z_{C,1,set}

Here, the first common latent data set Z_{C,1,set} may be configured to include a part or all of a specific codebook for CSI feedback previously agreed upon between the base station and the terminal. For example, each of the first common latent data Z_{C,1} included in the first common latent data set Z_{C,1,set} may correspond to a part or all of the specific codebook for CSI feedback. Alternatively, each of the first common latent data Z_{C,1} may be latent data generated by using a precoding matrix corresponding to the specific codebook for CSI feedback as input data.

The configurations according to the fifth exemplary embodiment of the feedback method described above may be applied together with at least part of other exemplary embodiments within a range that does not conflict with the other exemplary embodiments disclosed in the present disclosure.

### Sixth Exemplary Embodiment of Feedback Method

In the sixth exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

In the sixth exemplary embodiment of the feedback method, the base station may deliver an encoder function of the neural network #1 to the terminal (or first entity) as information on the common latent data set Z_{C,1,set} encoded by the neural network #1 from the common data input set X_{C,set}. The terminal (or first entity) may configure the encoder #2 of the neural network #2 based on the encoder function of the neural network #1.
1. Utilize the encoder #1 of the neural network #1 directly (or as is)
2. Configure the encoder #2 of the neural network #2 through training based on information on the encoder #1 of the neural network #1

Here, the base station may transmit information on the encoder #1 in a form of an artificial neural network model. Alternatively, the base station may transmit information on the encoder #1 in a form of model parameter(s) for the encoder #1. Alternatively, the base station may configure the information on the encoder #1 transmitted to the terminal so that the structure of the neural network model is not revealed as it is. For example, the information on the encoder #1, which is transmitted from the base station to the terminal, may be configured in a form that can only be executed by the terminal (e.g., function, library, binary file, etc.).

The configurations according to the sixth exemplary embodiment of the feedback method described above may be applied together with at least part of other exemplary embodiments within a range that does not conflict with the other exemplary embodiments disclosed in the present disclosure.

FIGS. 8A and 8B are conceptual diagrams for describing a seventh exemplary embodiment of an artificial neural network-based feedback method.

Referring to FIGS. 8A and 8B, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for a feedback procedure. Hereinafter, in describing the seventh exemplary embodiment of the artificial neural network-based feedback method (hereinafter, seventh exemplary embodiment of feedback method) with reference to FIGS. 8A and 8B, descriptions overlapping with those described with reference to FIGS. 1 to 7 may be omitted.

### Seventh Exemplary Embodiment of Feedback Method

In the seventh exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

In the seventh exemplary embodiment of the feedback method, the base station and the terminal may perform training for the neural network #1 and the neural network #2 based on the following training schemes.

First Training Scheme
1-A. The base station may transmit (or share) information on the common input data X_{C} and/or information on the first common latent data Z_{C,1} to (with) the terminal. Here, information on the common input data X_{C} may be information on the common input data set X_{C,set}. Information on the first common latent data Z_{C,1} may be information on the first common latent data set Z_{C,1,set}.
1-B. The terminal may train the neural network #2 so that the first loss function, the second loss function, and/or the third loss function are reduced. In other words, the terminal may train the neural network #2 so that the total loss function is reduced. Here, the total loss function may be composed of a combination of one or more loss functions of the first loss function, the second loss function, and the third loss function.

Second Training Scheme
2-A. Training stage #1 (800)
2-A-i. The base station and the terminal may train the neural network #1 and the neural network #2 so that the first loss function and/or the second loss function is reduced, respectively. In other words, the base station and the terminal may respectively train the neural network #1 and the neural network #2 so that the total loss function is reduced. Here, the total loss function may be composed of a combination of one or more loss functions of the first loss function and the second loss function.
2-B. Training stage #2 (850)
2-B-i. The base station may transmit (or share) information on the common input data X_{C} and/or information on the first common latent data Z_{C,1} to (with) the terminal. Here, information on the common input data X_{C} may be information on the common input data set X_{C,set}. Information on the first common latent data Z_{C,1} may be information on the first common latent data set Z_{C,1,set}.
2-B-ii. The terminal may train the neural network #2 so that the first loss function, the second loss function, and/or the third loss function are reduced. In other words, the terminal may train the neural network #2 so that the total loss function is reduced. Here, the total loss function may be composed of a combination of one or more loss functions of the first loss function, the second loss function, and the third loss function.

In the first training scheme and the second training scheme, the first loss function, the second loss function, and the third loss function may be respectively defined as follows.
(1) First loss function: The first loss function may be defined based on a relationship between output values (e.g., output data of each neural network) and correct values (e.g., input data of each neural network). For example, the terminal (or base station) may perform training in a direction in which an error between output data and input data is reduced in the neural network #2 (or neural network #1) based on the first loss function. The first loss function may be a reconstruction loss function.
(2) Second loss function: The second loss function may be defined based on a relationship between input values and output values of the encoder and/or decoder. For example, the second loss function may be defined based on a distance between input values of the encoder and/or decoder (hereinafter referred to as ‘input value distance’) and a distance between output values of the encoder and/or decoder (hereinafter referred to as ‘output value distance’). Based on the second loss function, the terminal (or the base station) may perform training in a direction such that the input value distance and the output value distance in the encoder and/or decoder are equal to each other or have a scaling relationship. If the input value distance and the output value distance in the encoder and/or decoder have the same value, the encoder and/or decoder may have isometric transformation characteristics. If the input value distance and the output value distance in the encoder and/or decoder have a scaling relationship with each other, the encoder and/or decoder may have scaled isometric transformation characteristics. For example, the terminal may identify a distance (hereinafter referred to as ‘input data distance’) between arbitrary third input data X₃ and fourth input data X₄ input to the encoder #2 and a distance (hereinafter referred to as ‘latent data distance’) between third latent data Z₃ and fourth latent data Z₄ output from the encoder #2. Based on the second loss function, the terminal may perform training in a direction such that the input data distance and the latent data distance are the same or have a scaling relationship. Accordingly, the encoder #2, the decoder #2, etc. may have isometric transformation characteristics or scaled isometric transformation characteristics.
(3) Third loss function: The third loss function may be defined based on an alignment loss, which is an error between the first common latent data set Z_{C,1,set} and the second common latent data set Z_{C,2,set}. The third loss function defined in the above-described manner may be referred to as an ‘alignment loss function’. The terminal (or base station) may perform training in a direction in which an error between the first common latent data set Z_{C,1,set} and the second common latent data set Z_{C,2,set} is reduced based on the third loss function.

In the second training scheme, a training stage #1 may correspond to the training stage #1 800 shown in FIG. 8A. Meanwhile, a training stage #2 may correspond to the training stage #2 850 shown in FIG. 8B.

Meanwhile, in the seventh exemplary embodiment of the feedback method, the base station and the terminal may perform training for the neural network #1 and the neural network #2 based on training schemes based on a Variational Auto Encoder (VAE) scheme as follows.

Third Training Scheme
3-A. The base station and/or terminal may perform training for the neural network #1 and/or neural network #2 using the VAE scheme.
3-B. The base station may transmit (or share) information on the common input data X_{C} to (with) the terminal. Here, information on the common input data X_{C} may include information such as a mean and/or a variance between values of the common input data X_{C} constituting the common input data set X_{C,set}.
3-C. The terminal may train the neural network #2 so that the first loss function, the second loss function, and/or the third loss function are reduced. In other words, the terminal may train the neural network #2 so that the total loss function is reduced. Here, the total loss function may be composed of a combination of one or more loss functions of the first loss function, the second loss function, and the third loss function.

Fourth Training Scheme
4-A. Training stage #1
4-A-i. The base station and/or terminal may perform training for the neural network #1 and/or neural network #2 using the VAE scheme.
4-B. Training stage #2
4-B-i. The base station may transmit (or share) information on the common input data X_{C} to (with) the terminal. Here, information on the common input data X_{C} may include information such as a mean and/or a variance between values of the common input data X_{C} constituting the common input data set X_{C,set}.
4-B-ii. The terminal may train the neural network #2 so that the first loss function, the second loss function, and/or the third loss function are reduced. In other words, the terminal may train the neural network #2 so that the total loss function is reduced. Here, the total loss function may be composed of a combination of one or more loss functions of the first loss function, the second loss function, and the third loss function.

In the third training scheme and the fourth training scheme, the first loss function, the second loss function, and the third loss function may be respectively defined as follows.
(1) First loss function: The first loss function may be defined based on a relationship between output values (e.g., output data of each neural network) and correct values (e.g., input data of each neural network). For example, the terminal (or base station) may perform training in a direction in which an error between output data and input data is reduced in the neural network #2 (or neural network #1) based on the first loss function. The first loss function may be a reconstruction loss function.
(2) Second loss function: The second loss function may be defined based on a latent loss for making the encoder and/or decoder follow the VAE scheme. The second loss function may be calculated as a Kullback Leibier (KL) divergence between a target distribution and an actual coding distribution according to the VAE scheme.
(3) Third loss function: The third loss function may be defined based on an error between a mean and variance of the first common latent data Z_{C,1} (or the set Z_{C,1,set} thereof) encoded by the neural network #1 from the common input data X_{C} (or the set X_{C,set} thereof) and a mean and variance of the second common latent data Z_{C,2} (or the set Z_{C,2,set} thereof) encoded by the neural network #2 from the common input data X_{C} (or the set X_{C,set} thereof).

In the above-described first to fourth training schemes, the terminal (or the base station) may perform training by simultaneously considering one or more loss functions among the first loss function, the second loss function, and the third loss function. Alternatively, the terminal (or base station) may separately perform the training process for each loss function.

Whether to apply each of the first loss function, the second loss function, and the third loss function (or configuration of the total loss function) may follow a scheme agreed in advance between the base station and the terminal. Alternatively, whether to apply each of the first loss function, the second loss function, and the third loss function (or configuration of the total loss function) may be configured to the terminal by the base station.

Here, the third loss function may be reflected (or applied) only when the training data is data within the common input data set. That is, the third loss function may not be reflected or may be reflected as a value of 0 when the training data is not data within the common input data set.

The training operations of the terminal based on the above-described first to fourth training schemes may be replaced by training operations of the first entity managing the neural network of the terminal. These may be the same as or similar to those in the third exemplary embodiment of the feedback method described with reference to FIG. 6 and the like.

The configurations according to the seventh exemplary embodiment of the feedback method described above may be applied together with at least part of other exemplary embodiments within a range that does not conflict with the other exemplary embodiments disclosed in the present disclosure.

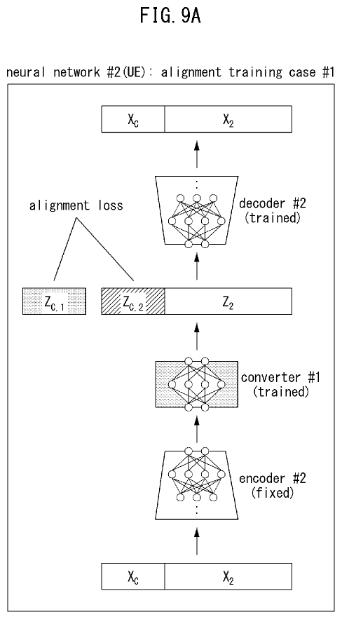

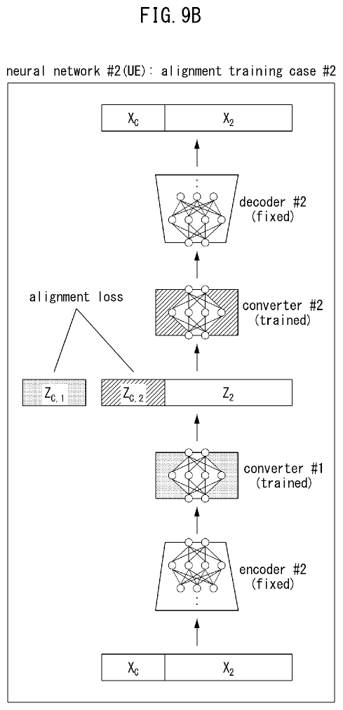

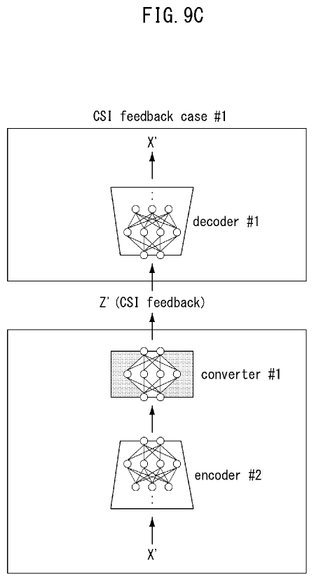

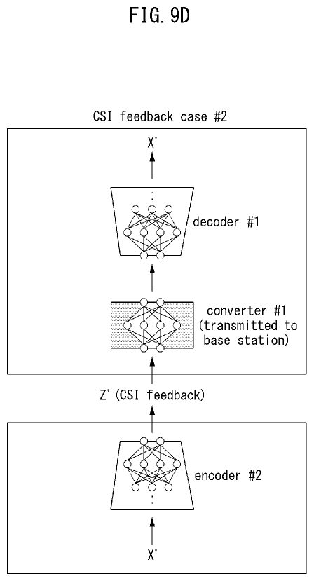

FIGS. 9A to 9D are conceptual diagrams for describing an eighth exemplary embodiment of an artificial neural network-based feedback method.

Referring to FIGS. 9A to 9D, in a communication system, a terminal may perform a feedback operation with respect to a base station. For example, the terminal may transmit a CSI feedback (or information corresponding to the CSI feedback) to the base station. The base station may receive the CSI feedback from the terminal. Such the feedback information transmission/reception operation between the base station and the terminal may be performed based on one or more artificial neural networks configured for a feedback procedure. Hereinafter, in describing the eighth exemplary embodiment of the artificial neural network-based feedback method (hereinafter, eighth exemplary embodiment of feedback method) with reference to FIGS. 9A to 9D, descriptions overlapping with those described with reference to FIGS. 1 to 8B may be omitted.

### Eighth Exemplary Embodiment of Feedback Method

In the eighth exemplary embodiment of the feedback method, a base station and a terminal may each include an artificial neural network (hereinafter referred to as ‘neural network’) configured for a feedback procedure (e.g., CSI feedback procedure). The base station may include a neural network #1, and the terminal may include a neural network #2. Each of the neural network #1 and the neural network #2 may have an auto-encoder structure. Each neural network may include an encoder and a decoder. For example, the neural network #1 included in the base station may include an encoder #1 and a decoder #1. The neural network #2 included in the terminal may include an encoder #2 and a decoder #2. The structure of the neural network #1 may be the same as or similar to the structure of the neural network #1 described with reference to FIG. 4B. The structure of the neural network #2 may be the same as or similar to the structure of the neural network #2 described with reference to FIG. 4C. The base station and the terminal may transmit and receive feedback information based on the neural network #1 and the neural network #2.

Referring to FIGS. 9A and 9B, in the eighth exemplary embodiment of the feedback method, the neural network #2 may include one or more converters in addition to the structure of the neural network #2 described with reference to FIG. 4C. Each of the one or more converters may be an artificial neural network-based converter block. Meanwhile, each of the one or more converters may be in a form of a computation block rather than an artificial neural network. For example, each of the one or more converters may be a computation block that performs a Procrustes transformation.

The one or more converters may be configured for supporting compatibility. The terminal may perform alignment training for the neural network #2 including one or more converters. The one or more converters may be added to the neural network #2 in the same manner as in an alignment training case #1 shown in FIG. 9A or an alignment training case #2 shown in FIG. 9B.

Alignment Training Case #1

Referring to FIG. 9A, in the alignment training case #1, the neural network #2 of the terminal may additionally include a converter #1 at a rear end of the encoder #2. Here, weights of the encoder #2 and/or decoder #2 may be fixed, and weights of the converter #1 may be updated through training.

Specifically, the terminal may encode feedback information using the encoder #2, and convert the encoded feedback information through the converter #1. The terminal may transmit the feedback information converted by the converter #1 to the base station. The base station may decode the feedback information transmitted from the terminal using the decoder #1. To this end, the terminal may perform training for the converter #1 in a direction in which an error (i.e., alignment loss) between the first common latent data Z_{C,1} and the second common latent data Z_{C,2} is reduced.

That is, the input data X including the common input data X_{C} and second input data X₂ may be input to the encoder #2. The encoder #2 may output intermediate data Y. The intermediate data Y may include second common intermediate data Y_{C,2} corresponding to the common input data X_{C} and second intermediate data Y₂ corresponding to the second input data X₂. The intermediate data Y may be input to the converter #1. The converter #1 may output the latent data Z. The latent data Z may include second common latent data Z_{C,2} corresponding to the common input data X_{C} and second latent data Z₂ corresponding to the second input data X₂.

In the alignment training case #1, the terminal may perform training for the converter #1 and/or converter #2 in a direction in which an error (i.e., alignment loss) between the first common latent data Z_{C,1} provided from the base station and the second common latent data Z_{C,2} output from the converter #1 is reduced.

Alignment Training Case #2

Referring to FIG. 9B, in the alignment training case #1, the neural network #2 of the terminal may additionally include the converter #2 in front of the decoder #2. Here, weights of the encoder #2 and the decoder #2 may be fixed, and weights of the converter #2 may be updated through training.

Specifically, the terminal may provide information on the converter #2 to the base station. The terminal may encode feedback information using the encoder #2 and transmit the encoded feedback information to the base station. The base station may convert the feedback information transmitted from the terminal based on the converter #2 provided from the terminal. The base station may interpret or restore feedback information to be transmitted from the terminal by decoding outputs of the converter #2 through the decoder #2. To this end, the terminal may perform training for the converter #1 in a direction in which an error (i.e., alignment loss) between the first common latent data Z_{C,1} and the second common latent data Z_{C,2} is reduced.

That is, the input data X including the common input data X_{C} and second input data X₂ may be input to the encoder #2. The encoder #2 may output the latent data Z. The latent data Z may include the second common latent data Z_{C,2} corresponding to the common input data X_{C} and the second latent data Z₂ corresponding to the second input data X₂. The base station may input the latent data Z (or part thereof) reported by the terminal to the converter #2. The converter #2 may output first intermediate data Y₁. The base station may input the first intermediate data Y₁ to the decoder #2. Output data output from the decoder #2 may be an interpretation (or restoration) result of the input data X (or part thereof) to be reported by the terminal.

Meanwhile, in another exemplary embodiment of the alignment training case #2, the neural network #2 may include both the converter #1 after the encoder #2 and the converter #2 before the decoder #2.

Referring to FIGS. 9C and 9D, the feedback operation may be performed based on the aforementioned alignment training case #1 or case #2.

Feedback Case #1

Referring to FIG. 9C, in the feedback case #1, a feedback operation may be performed based on the alignment training case #1. Latent data Z′ may be generated by encoding feedback information X′ that the terminal wants to report through encoding in the encoder #2 and conversion in the converter #1. When the latent data Z′ is provided to the base station, the feedback information X′ may be restored by being decoded by the decoder #1 in the base station.

Feedback Case #2

Referring to FIG. 9D, in the feedback case #2, a feedback operation may be performed based on the alignment training case #2. Latent data Z′ may be generated by encoding feedback information X′ that the terminal wants to report through encoding in the encoder #2. When the latent data Z′ is provided to the base station, the base station may input the latent data Z′ to the converter #1 provided by the terminal. The feedback information X′ may be restored by converting the latent data Z′ through encoding in the converter #1 and decoding in the decoder #1.

The configurations according to the eighth exemplary embodiment of the feedback method described above may be applied together with at least part of other exemplary embodiments within a range that does not conflict with the other exemplary embodiments disclosed in the present disclosure.

The configurations according to the above-described first to tenth exemplary embodiments of the feedback method are merely examples for convenience of description, and exemplary embodiments of the artificial neural network-based feedback method are not limited thereto. At least some of the configurations according to the first to tenth exemplary embodiments of the feedback method may be equally or similarly applied even in a situation where the base station is replaced by the terminal and the terminal is replaced by the base station. Alternatively, at least some of the configurations according to the first to tenth exemplary embodiments of the feedback method may be equally or similarly applied even in a situation where the base station and the terminal are replaced by a first communication node and a second communication node, respectively. That is, the configurations according to the first to tenth exemplary embodiments of the feedback method may be equally or similarly applied to a situation in which feedback information is transmitted and received in communication between an arbitrary first communication node and an arbitrary second communication node. For example, for a first feedback procedure between the first and second communication nodes, the neural network #1 and the neural network #2 may be configured in the first communication node and the second communication node. The first communication node may encode first feedback information using the neural network #1 and transmit the encoded first feedback information to the second communication node. The second communication node may decode the first feedback information using the neural network #2, and through this, may interpret or restore feedback information to be transmitted by the first communication node.

In the first to tenth exemplary embodiments of the above-described feedback method, it has been described that the neural network #1 of the first communication node and the neural network #2 of the second communication node both include the encoder and the decoder. However, this is for convenience of description, and exemplary embodiments of the artificial neural network-based feedback method are not limited thereto. The neural network #1 of the first communication node may include some or all of the encoder #1 and the decoder #1. The neural network #2 of the second communication node may include some or all of the encoder #2 and the decoder #2. For example, in an exemplary embodiment of the communication system, the neural network #1 of the first communication node may include the encoder #1 and the decoder #1, and the neural network #2 of the second communication node may include only the encoder #2 without the decoder #2.

According to exemplary embodiments of an artificial neural network-based feedback information transmission and reception method and apparatus in a communication system, communication nodes (e.g., base station and terminal) in the communication system may include an artificial neural network for a feedback procedure (e.g., CSI feedback procedure). In a transmitting node that transmits feedback information, feedback information in a compressed form may be generated through an encoder of the artificial neural network. A receiving node receiving the feedback information may receive the compressed form of feedback information from the transmitting node. The receiving node may restore original feedback information from the compressed form of the feedback information through a decoder of the artificial neural network. Through this, the performance of the artificial neural network-based feedback information transmission/reception operation can be improved.

However, the effects that can be achieved by the exemplary embodiments of the artificial neural network-based feedback information transmission/reception method and apparatus in the communication system are not limited to those mentioned above, and other effects not mentioned may be clearly understood by those of ordinary skill in the art to which the present disclosure belongs from the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a first communication node, comprising:
inputting first input data including first feedback information to a first encoder of a first artificial neural network corresponding to the first communication node;
generating first latent data based on an encoding operation in the first encoder;
generating a first feedback signal including the first latent data; and
transmitting the first feedback signal to a second communication node,
wherein the first latent data included in the first feedback signal is decoded into first restored data corresponding to the first input data in a second decoder of a second artificial neural network corresponding to the second communication node, and the first input data includes first common input data included in a common input data set previously shared between the first communication node and the second communication node.

2. The operation method according to claim 1, further comprising, before the inputting of the first input data,
receiving information at least on the second encoder of the second artificial neural network from the second communication node; and
configuring the first encoder based on information on the second encoder.

3. The operation method according to claim 1, further comprising, before the inputting of the first input data, performing a pre-training procedure for pre-training the first artificial neural network, wherein the pre-training procedure is performed based on a first common latent data set generated in the first communication node based on the common input data set, and a second common latent data set generated in the second communication node based on the common input data set.

4. The operation method according to claim 3, wherein the performing of the pre-training procedure comprises:
generating, by the first encoder, the first common latent data set based on the common input data set;
receiving, from the second communication node, information on the second common latent data set generated based on the common input data set in the second encoder of the second artificial neural network of the second communication node; and
updating the first artificial neural network based on a relationship between the first and second common latent data sets.

5. The operation method according to claim 4,
wherein the updating of the first artificial neural network comprises updating the first artificial neural network so that values of one or more loss functions of a first loss function, a second loss function, and a third loss function decrease, and
wherein:
the first loss function is defined based on an error between an input value and an output value of the first artificial neural network,
the second loss function is defined based on a ratio between an input value distance and an output value distance of the first encoder and/or a first decoder of the first artificial neural network, and
the third loss function is defined based on an error between the first and second common latent data sets.

6. The operation method according to claim 4,
wherein the performing of the pre-training procedure comprises, before the generating of the first common latent data set, updating the first artificial neural network so that values of one or more of a first loss function and a second loss function decrease, and
wherein the first loss function is defined based on an error between an input value and an output value of the first artificial neural network, and the second loss function is defined based on a ratio between an input value distance and an output value distance of the first encoder and/or a first decoder of the first artificial network.

7. The operation method according to claim 1, further comprising, after the transmitting of the first feedback signal,
receiving, from the second communication node, information on a third common latent data set generated based on the common input data set in a second encoder of the second artificial neural network of the second communication node; and
performing an update procedure for the first artificial neural network based on at least the information on the third common latent data set.

8. The operation method according to claim 7, wherein the information on the third common latent data set includes first identification information on the common input data set in a state corresponding to the third common latent data set, and the performing of the update procedure comprises:
determining whether an update for the first artificial neural network has already been performed based on the common input data set in a state corresponding to the first identification information; and
in response to determining that the update for the first artificial neural network has already been performed based on the common input data set in the state corresponding to the first identification information, determining that an update for the first artificial neural network based on the third common latent data set is not required.

9. The operation method according to claim 8, wherein the first identification information includes at least part of information on a supplier of the common input data set, information on a version of the common input data set, or information on a model of the second artificial neural network of the second communication node.

10. The operation method according to claim 1, further comprising:
determining whether a feedback procedure based on a fallback mode is required;
in response to determining that the feedback procedure based on the fallback mode is required, identifying latent variables included in a second common latent data set based on the common input data set at the second communication node;
generating second latent data from second input data based on the latent variables;
generating a second feedback signal including the second latent data; and
transmitting the second feedback signal to the second communication node.

11. The operation method according to claim 10, wherein the determining of whether the feedback procedure based on the fallback mode is required comprises: determining that the feedback procedure based on the fallback mode is required at least one of: when the first artificial neural network is deactivated, when the second artificial neural network is deactivated, when configurations related to artificial neural network-based feedback are changed in the first communication node, or when the first communication node is in handover.

12. The operation method according to claim 1, wherein the first artificial neural network includes a first converter at a rear end of the first encoder, and the generating of the latent data comprises:
generating first intermediate data based on the encoding operation on the first input data in the first encoder; and
inputting the first intermediate data to the first converter to convert the first intermediate data into the first latent data.

13. The operation method according to claim 1, further comprising, before the inputting of the first input data,
generating a first converter to be used in the second communication node; and
transmitting information on the first converter to the second communication node,
wherein the first latent data is converted by the first converter provided from the first communication node before being input to the second decoder at the second communication node.

14. The operation method according to claim 1, further comprising, when the first artificial neural network further includes a first decoder and a second converter,
generating third latent data by inputting third input data to the first encoder;
generating second intermediate data by inputting the third latent data to the second converter; and
generating third output data corresponding to the third input data by inputting the second intermediate data to the first decoder.

15. The operation method according to claim 1, further comprising, before the inputting of the first input data,
receiving, from the second communication node, information on a second common latent data set generated based on the common input data set in a second encoder of the second artificial neural network of the second communication node; and
transmitting pre-training request information for pre-training the first artificial neural network to a first entity,
wherein the pre-training request information includes information on the second common latent data set, and the pre-training is performed by the first entity based on the information on the second common latent data set.

16. The operation method according to claim 1, further comprising, after the transmitting of the first feedback signal,
receiving, from the second communication node, information on a third common latent data set generated based on the common input data set in a second encoder of the second artificial neural network of the second communication node; and
transmitting update request information for updating the first artificial neural network to a first entity,
wherein the update request information includes information on the third common latent data set, and the updating of the first artificial neural network is performed by the first entity based on the information on the third common latent data set.

17. The operation method according to claim 16, wherein the update request information further includes information on at least one common data pair composed of at least one common input data included in the common input data set and at least one common latent data included in the third common latent data set.

18. An operation method of a first communication node, comprising:
receiving a first feedback signal from a second communication node;
obtaining first latent data included in the first feedback signal;
performing a decoding operation on the first latent data based on a first decoder of a first artificial neural network corresponding to the first communication node; and
obtaining first feedback information based on first restored data output from the first decoder,
wherein the first feedback information corresponds to second feedback information generated for a feedback procedure in the second communication node, the second communication node generates the first latent data included in the first feedback signal by encoding first input data including the second feedback information through a second encoder of a second artificial neural network corresponding to the second communication node, and the first input data includes first common input data included in a common input data set previously shared between the first communication node and the second communication node.

19. The operation method according to claim 18, further comprising, before the receiving of the first feedback signal,
generating a first common latent data set for a pre-training procedure for the second artificial neural network of the second communication node by encoding the common input data set through a first encoder of the first artificial neural network; and
transmitting the first common latent data set to the second communication node,
wherein the pre-training procedure is performed based on the first common latent data set and a second common latent data set generated in the second communication node based on the common input data set.

20. The operation method according to claim 18, further comprising, after the obtaining of the first feedback information,
generating a third common latent data set for an update procedure for the second artificial neural network of the second communication node by encoding the common input data set through a first encoder of the first artificial neural network; and
transmitting information on the third common latent data set to the second communication node,
wherein the information on the third common latent data set includes first identification information on the common input data set in a state corresponding to the third common latent data set, and the first identification information is used to determine whether an update for the second artificial neural network is required in the second communication node.
